(19) United States
(12) Patent Application Publication
(10) Pub. No.: US 2008/0274262 A1
(43) Pub. Date: Nov. 6, 2008

(54) Bread crumb analog and food comprising the same

(75) Inventors: Keiko Yamaku, Chuo-ku (JP); Masaru Goto, Chuo-ku (JP); Atsuo Tamakoshi, Chuo-ku (JP)

Correspondence Address: OLIFF & BERRIDGE, PLC, P.O. BOX 320850, ALEXANDRIA, VA, 22320-4850, US

(73) Assignee: J-OIL MILLS INC., Tokyo (JP)

(21) Appl. No.: 12/216,298

(22) Filed: Jul. 2, 2008

Related U.S. Application Data
(63) Continuation of application No. 11/007,263, filed on Dec. 9, 2004.

(30) Foreign Application Priority Data
Dec. 10, 2003 (JP) 2003-411176

(51) Int. Cl. A23L 1/216; A23P 1/00

(52) U.S. Cl. 426/637; 426/456; 426/464

(57) ABSTRACT

A good-taste, good-appearance bread crumb analog having an improved crispy oral sensation. The bread crumb analog is prepared by heat-treating raw material containing at least 15 percent by weight of dehydrated potatoes, e.g., potato flakes and/or potato powder.

This is a Continuation of application Ser. No. 11/007,263 filed Dec. 9, 2004, which claims the benefit of Japanese Patent Application 2003-411176, filed Dec. 10, 2003. The entire disclosure of the prior applications is hereby incorporated by reference herein in its entirety.

### BACKGROUND

1. Field of the Invention

The present invention relates to a bread crumb analog which provides improved taste and flavor, appearance and oral sensation (organoleptic feeling), in comparison with conventionally used bread crumbs, cracker powder and similar grains or flakes. The present invention also relates to food using the same.

2. Description of the Related Art

In general, bread crumbs are produced by pulverizing bread made of wheat flour by baking or an electrode method. In recent years, cornflakes, potato flakes or the like have been used instead of bread crumbs in various cases. Although food coated with cornflakes or potato flakes provides distinctive good taste and flavor and appearance, its oral sensation is undesirably “hard”. In order to solve this problem, some techniques have been proposed. For example, Japanese Patent No 3362962 discloses a method of using potato flakes and hardened edible fats and oils in combination. Japanese Patent Application Laid-open No. Hei 9-168372 discloses a method for producing bread crumbs by adding an emulsifier, a pregelatinized potato and alpha amylase to grain flour. However, while the potato flakes produced by the method of Japanese Patent No. 3362962 improve the oral sensation of food, a peculiar smell resulting from hydrogenation for hardening the edible oil remains in the food to adversely affect the taste and flavor. In the method of Japanese Patent Application Laid-open No. Hei 9-168372, since an emulsifier and alpha amylase are used to adjust the hardness, the bread crumbs allow strange or different taste to remain in mouth, and are thus unsuitable as food. Also, the pregelatinized potato content is as low as 1 to 10%. When such a large amount of pregelatinized potato as to impart the taste of potato is added, the oral sensation becomes to “hard” or the suitability for making bread is degraded to vary the quality of the bread and eventually to vary the quality of the resulting bread crumbs.

Other methods have also been proposed for producing breadcrumb-like food by processing raw materials with an extruder. For example, Japanese Patent Application Laid-open No. Sho 64-63348 discloses a method of processing yellow corn as raw material with an extruder. Japanese Patent Application Laid-open No. Sho 61-108346 discloses a method of processing grain flour and/or vegetable protein with an extruder. However, the resulting breadcrumb-like food remains smell derived from the yellow corn or the vegetable protein and, thus, does not have good taste and flavor. A method for producing cracker powder analog by using grain as main raw material is disclosed in Japanese Patent Application Laid-open No. 2002-253156. However, since the method of Japanese Patent Application Laid-open No. 2002-253156 is mainly intended to improve the oral sensation and uses grain as the main raw material, it is not satisfactory in terms of improving the taste and flavor.

### SUMMARY

Accordingly, an object of the present invention is to provide a novel bread crumb and bread crumb analog which can overcome the above-described disadvantages in applying bread crumb and bread crumb analogs to food, and which provides good taste and flavor and has good appearance and an improved crispy feeling.

The present inventors have conducted intensive research to overcome the above-described disadvantages, and have found that bread crumb and bread crumb analog made by adding suitable amount of water to dehydrated potatoes and carrying out heat-treatment provide good taste and flavor, good appearance and good oral sensation even when they are applied to various types of food. Specially, the present invention is directed to bread crumb and bread crumb analog obtained by heat-treating raw material containing at least 15 percent by weight of dehydrated potatoes, e.g., potato flakes and/or potato powder. The present invention uses an extruder as heat-treating means.

When the bread crumb and bread crumb analog of the present invention are used, good fried color and potato's distinctive savory taste and flavor to fried food can be imparted. The resulting fried food is not too hard in oral sensation of coating, and can maintain its crispy oral sensation for a long time. The bread crumb analog can be kneaded with dough such as minced meat, fish paste or the like in the same manner as common bread crumbs; kneaded with or attached to dough of snack food or bakery product; or mixed with cereal materials. Even in these applications, it can provide potato's distinct taste and flavor.

### DETAILED DESCRIPTION OF EMBODIMENTS

The dehydrated potatoes used in the present invention are prepared by dehydrating or drying potatoes, and they are potato materials in various forms of potato flakes, potato powder, potato flour, granular potato flour and potato pieces, or dice, slices and shred of potatoes. Potato flakes and/or potato powder are preferable from the viewpoint of workability and costs.

The dehydrated potatoes content in the raw materials is 15% by weight or more, and preferably 30% by weight or more. Dehydrated potatoes content of less than 15% by weight results in food having weak potato's distinctive taste and flavor, and cannot produce a sufficient effect of improving oral sensation. Also, the coloration of the food is poor. Accordingly, additives, such as colorant, are required.

Other main raw materials used in combination with the potato flakes or powder include grains such as rice, wheat, corn, white corn, barley, rye, sorghum, and milo; beans such as soybeans, peas and mung beans; starches such as cornstarch, potato starch, wheat starch, tapioca starch, and other food-modified starch; and proteins such as soybean protein, whey protein and wheat protein. These materials may be added singly or in combination. From the viewpoint of workability and availability, grains, especially wheat or white corn are used in the form of crushed materials or pulverized materials though rice and the like may be used as they are.

The process for producing the bread crumb analog of the present invention is not particularly limited. For example, bread produced by a generally known method, such as baking or an electrode method, may be pulverized, or a mixture of raw materials extruded and puffed with an extruder may be pulverized. If a large amount of dehydrated potatoes, e.g., potato flakes and/or powder is added to the mixture of raw materials, the mixture becomes unsuitable to bake bread. In such a case, a process for extruding and puffing raw materials by using an extruder is preferably applied. For extrusion and rising, dehydrated potatoes as main raw material or a mixture of dehydrated potatoes and grains and/or starches are processed with an extruder under conditions of 80 to 200° C., preferably 100 to 180° C., more preferably 140 to 170° C., a water content of 15 to 50% by weight, preferably 15 to 40% by weight, more preferably 20 to 35% by weight, a screw rotation speed of 100 to 1,000 rpm and heat-treating time of 5 to 60 seconds. The extruded mixture may be used as it is. Alternatively, the extruded mixture, if necessary, may be dried and pulverized, and the grains are sized so as to have a specific gravity in the range of 0.07 to 0.7 g/mL and a mean particle size in the range of 0.1 to 5.0 mm, as common cracker powder or bread crumbs are processed.

In addition to the above-described main raw materials, subsidiary raw materials, such as oils and fats, saccharide, polysaccharide, protein and emulsifier may be used to further improve the oral sensation so that the resulting bread crumb analog has a crispy oral sensation. The bread crumb analog of the present invention may be singly used in various food applications, or it may be blended with other bread crumbs or analogs thereof to such an extent as not to degrade the effect of the present invention.

The oils and fats used as a subsidiary raw material is not particularly limited as long as it is edible, and the examples of the oils and fats include vegetable oils such as soybean oil, rapeseed oil, sunflower oil, olive oil, high-oleic rapeseed oil, palm oil, palm kernel oil, coconut oil, corn oil, high-linoleic safflower oil, high-oleic safflower oil and cottonseed oil; and animal fats, such as beef tallow, lard, fish oil and milk fat. These oils and fat may be hydrogenated (hardened), transesterified, fractionated, or subjected to other physical or chemical treatment. Oils and fats analogs such as monoglycerides and diglycerides, fatty acids which are constituents of the oils and fats, and fatty acid derivatives may be alternative to the oils and fats. The oils and fats may be in a form of butter, margarine, shortening or powder oils and fats. The above-listed oils and fats may be used singly or in combination. Content of the oils and fats is preferably 0.1 to 20 parts by weight relative to 100 parts by weight of the main raw material, and mom preferably 0.1 to 10 parts by weight.

The sacharide used as a subsidiary raw material is not particularly limited as long as it is edible, and examples of the saccharide include glucose, sucrose, fructose, maltose, arabinose, xylose, ribose, galactose, galacturonic acid, uronic acid, rhamnose, fucose, mannose, and starch syrup containing a reducing sugar constituted of saccharide. These saccharides may be used singly or in combination. The saccharide content is preferably 0.1 to 100 parts by weight relative to 100 parts by weight of the main raw material, and more preferably 0.5 to 20 parts by weight.

The polysaccharide used as a subsidiary raw material is not particularly limited as long as it is edible, and examples of the polysaccharide include dextrin; gums such as xanthan gum, guar gum, tamarind seed gum, locust bean gum, psyllium seed gum, carrageenan, pectin, glucomannan, alginic acid, sodium alginate, curdlan, gum Arabic, gellan gum, pullulane, chitin, and chitosan; dietary fiber derived from wheat, barley, rye, corn, or beans; and commercially available celluloses. These polysaccharides may be used singly or in combination. The polysaccharide content is preferably 0.1 to 20 parts by weight relative to 100 parts by weight of the main raw material, and mom preferably 0.1 to 10 parts by weight.

The protein used as a subsidiary raw material is not particularly limited as long as it is edible, and examples of the protein include albumin, yolk, hen's eggs (whole eggs), whey protein, casein, sodium caseinate, whole-fat milk non-fat dry milk, collagen, gelatin, blood plasma protein, wheat protein, soybean protein, and pea protein. These proteins may be used singly or in combination. The protein content is preferably 1 to 100 parts by weight relative to 100 parts by weight of the main raw material, and more preferably 1 to 20 parts by weight.

The emulsifier used as a subsidiary raw material is not particularly limited as long as it is edible, and examples of the emulsifier include monoglycerides, organic acid monoglycerides, polyglycerol fatty acid esters, polyglycerol polyricinoleate, sorbitan fatty acid esters, polypropylene glycol fatty acid esters, sucrose fly acid esters, calcium stearoyl lactylate, lecithin, enzyme digested lecithin, and enzyme treated lecithin. Among these, the most suitable are monoglycerides. These emulsifiers may be used singly or in combination. The emulsifier content is preferably 0.01 to 10 parts by weight relative to 100 parts by weight of the main raw material, and more preferably 0.05 to 5 parts by weight.

The bread crumb and bread crumb analog of the present invention is used in various food applications, such as for fried food, batter dough, coating, bread, cake and minced meat food, such as hamburg steaks, shao-mai and dumpling stuffed with minced pork. In particular, the bread crumb analog can exhibit effectively its characteristic features in use for fried food, batter, coating, bread and cake.

The present invention will be further described with reference to examples. However, the form and details of the invention are not limited by the examples.

### EXAMPLES

Raw materials were compounded in proportions according to Examples 1 to 4 shown in Table 1. Each mixture was processed with an extruder at a temperature of 160° C., a water content of 30% by weight, and a screw rotation speed of 850 rpm. The extruded and puffed mixture was dried to a war content of less than 10%. Then, the particle size of the mixture was adjusted by a sizer and the adjusted mixture was passed through a sieve having sieve opening of 2.5 mm, and a fraction of the passed mixture was retained on a sieve having sieve opening of 0.15 mm, whereby obtaining test samples of the bread crumb and bread crumb analog. The average particle sizes of the obtained test samples of the bread crumb and bread crumb analog is 1.5 mm.

The extruder used in the present invention is a two-axle extruder BCTG 62 (manufactured by Buhler Inc.) in which a screw diameter 62 mm, axle length is 1240 mm and feed speed is 500 kg/hr.

### COMPARATIVE EXAMPLES

Raw materials were compounded in a proportion of Comparative Example 1 shown in Table 1. The mixture was processed with an extruder at a temperature of 160° C., a water content of 30% by weight, and a screw rotation speed of 850 rpm. The extruded and puffed mixture was dried to a water content of less than 10%, and granulated and sized to a particle size of 0.1 to 5 mm with a sizer. Thus, bread crumb and bread crumb analog samples of Comparative Example 1 was prepared. For Comparative Example 2, unheated potato flakes were prepared, and sized to a particle size of 0.1 to 5 mm with a sizer.

TABLE 1

| | | | | | Comparative |
|---|---|---|---|---|---|
| | Example 1 | Example 2 | Example 3 | Example 4 | Example 1 |
| Potato | 100 | 50 | 15 | 50 | 0 |
| flakes | | | | | |
| Wheat | 0 | 50 | 85 | 50 | 100 |
| flour | | | | | |
| Emulsifier | 1 | 1 | 1 | 0 | 1 |

Potato flakes: Dried mashed potato flakes produced by Snow Brand Milk Products Co., Ltd.
Wheat flour: soft wheat flour “FLOUR” produced by Nisshin Flour Milling Inc.
Emulsifier: glycerol fatty acid esters “EMALUSY MS” produced by Riken Vitamin Co., Ltd.

### Test Example 1

Batter was prepared by adding 2,000 g of water to 1,000 g of wheat flour and mixing them. The obtained batter was coated to 20 g pieces of chicken leg meat uniformly and thinly. The chicken leg pieces were further uniformly coated with the bread crumb and bread crumb analogs or potato flakes of the Examples and Comparative Examples, and fried in oil at 160° C. for 5 minutes to yield fried chicken samples. The fried chicken samples were subjected to sensory evaluation by ten panelists. Each panelist marked samples of the fried chicken on a scale of 10. Table 2 shows total points.

TABLE 2

| | Example | Example | Example | Example | Comparative | Comparative |
|---|---|---|---|---|---|---|
| | 1 | 2 | 3 | 4 | Example 1 | Example 2 |
| Taste, | 100 | 87 | 75 | 86 | 26 | 96 |
| flavor | | | | | | |
| Appearance | 92 | 95 | 76 | 90 | 36 | 74 |
| Oral | | | | | | |
| sensation | 97 | 94 | 90 | 73 | 35 | 23 |

### Test Example 2

Batter was prepared by adding 2,000 g of water to 1,000 g of wheat flour and mixing them. The obtained batter was coated to pretreated shrimps uniformly and thinly. The shrimps were further uniformly coated with the bread crumb, bread crumb analogs or potato flakes of Examples and Comparative Examples, and fried in oil at 170° C. for 3 minutes to yield fried shrimp samples. The fried shrimp samples were subjected to sensory evaluation by ten panelists. Each panelist marked samples of the fried shrimps on a scale of 10. Table 3 shows total points.

TABLE 3

| | Example | Example | Example | Example | Comparative | Comparative |
|---|---|---|---|---|---|---|
| | 1 | 2 | 3 | 4 | Example 1 | Example 2 |
| Taste, | 98 | 91 | 78 | 94 | 30 | 94 |
| flavor | | | | | | |
| Appearance | 96 | 95 | 80 | 92 | 42 | 77 |
| Oral | | | | | | |
| sensation | 100 | 96 | 88 | 71 | 34 | 25 |

What is claimed is:

1. A method of preparing a bread crumb analog, the method comprising:
forming a mixture comprising at least 15% by weight of dehydrated potatoes, and 15% to 50% by weight of water; and
heat-treating the mixture with an extruder at a temperature of 80° C. to 200° C. for a heat-treating time of 5-60 seconds.

2. The method according to the claim 1, wherein the dehydrated potatoes are potato flakes and/or potato powder.

3. The method according to the claim 1, wherein the mixture further comprises at least one member selected from the group consisting of rice, wheat, and corn.

4. The method according to claim 3, wherein the mixture further comprises at least one member selected from the group consisting of oils, fats, saccharides, polysaccharides, proteins, and emulsifiers.

5. The method according to the claim 1, wherein the heat-treating is done at a temperature of 140° C. to 170° C.

6. The method according to claim 1, wherein heat-treating the mixture with an extruder is done with a screw rotation speed of 100 to 1,000 rpm.

7. The method according to claim 1, wherein the mixture comprises at least 30% by weight of dehydrated potatoes.

8. The method according to claim 1, wherein the mixture comprises 20% to 35% by weight of water.

9. The method according to claim 1, further comprising:
drying and pulverizing the heat-treated mixture into grains having a mean particle size in the range of 0.1 to 5.0 mm and a specific gravity in the range of 0.07 to 0.7 g/mL.

10. A food product comprising the bread crumb analogs made by the method of claim 1.
